(19) United States
(12) Patent Application Publication
(10) Pub. No.: US 2021/0372163 A1
(43) Pub. Date: Dec. 2, 2021

(54) TRAILER DOOR HASP LOCK

(71) Applicant: Phillip Wyers, Centennial, CO (US)

(72) Inventor: Phillip Wyers, Centennial, CO (US)

(21) Appl. No.: 17/316,306

(22) Filed: May 10, 2021

Related U.S. Application Data
(60) Provisional application No. 62/987,534, filed on Mar. 10, 2020.

(51) Int. Cl. E05B 45/06; E05B 65/48; E05B 83/02

(52) U.S. Cl. CPC E05B 45/06; E05B 65/48; E05B 2045/065; E05B 2045/064; E05B 83/02

(57) ABSTRACT

A dual hasp conventional trailer door lock has a lever arm that is secured between a fixed lower hasp and a swivel upper hasp so as to align an upper hasp hole with a lower hasp hole. The present invention has an elongate body that rests against the door to cover the two hasps. A lockable pin is manually pushed through the holes from a key end to an anchor end of the lock body. An electronic motion sensor is housed in a hollow in the body. Any tampering of the body triggers any one of an alarm sound and/or phone transmission and/or flashing strobe light.

### FIELD OF THE INVENTION

The present invention relates to combining a motion detector in a conventional upper and lower hasp lock for a trailer door.

### BACKGROUND

Trailers have many moving parts and exposed door hinges that can be attacked.

Known in the art are mechanical locks that cover the pivoting lever arm on a trailer door and then inserts a locking pin thru the upper and lower hasps. Traditionally the upper hasp pivots upward to allow the lever arm to rest on the lower hasp. Then the upper hasp is pivoted down over the lever arm. The locking pin travels through the holes in the upper and lower hasp so as to prevent any movement of the lever arm. One model is the Blaylock Model DL-80 Universal Cam Bar Lock. A locking pin is pushed down in the lock body. A recessed lock tumbler push button locks the pin in place. A key releases the lock tumbler.

What is needed in the art is a built in weatherproof electronic motion detector which transmits a loud alarm if anyone starts to tamper with the door hasp lock or other parts of the trailer. The present invention mounts a battery powered motion detector with speaker in a cavity in the door hasp lock behind the locking pin. For practical ease of use, the motion sensor can be activated or deactivated with a small key fob, or cell phone. This is critical in a trailer application so the user can easily activate alarm when trailer is stationary for the night, and deactivate quickly before towing in the morning. Key activation can also be used along with a push button on the lock housing.

### SUMMARY OF THE INVENTION

The main aspect of the present invention is to provide a lock body, preferably aluminum, that houses a recessed electronic module that has a replaceable battery, a motion detector and a speaker.

Another aspect of the present invention is to locate the speaker adjacent the lever arm so as to be inaccessible when the lock is locked.

Another aspect of the present invention is to design the body in a bullet like shape with a cavity for the motion detector.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 is a top perspective view of the door hasp lock.

FIG. 2 is a top plan view.

FIG. 3 is a bottom perspective view.

FIG. 4 is a bottom plan view.

FIG. 5 is a longitudinal cutaway view.

FIG. 6 is a left side elevation view.

FIG. 7 is a right side elevation view.

FIG. 8 is a bottom perspective view in use.

FIG. 9A is an exploded view of an end mounted motion detector.

FIG. 9B is a longitudinal sectional view of the assembled FIG. 9A embodiment.

Before explaining the disclosed embodiments in detail, it is to be understood that the embodiments are not limited in application to the details of the particular arrangements shown, since other embodiments are possible. Also, the terminology used herein is for the purpose of description and not of limitation.

### DETAILED DESCRIPTION OF THE DRAWINGS

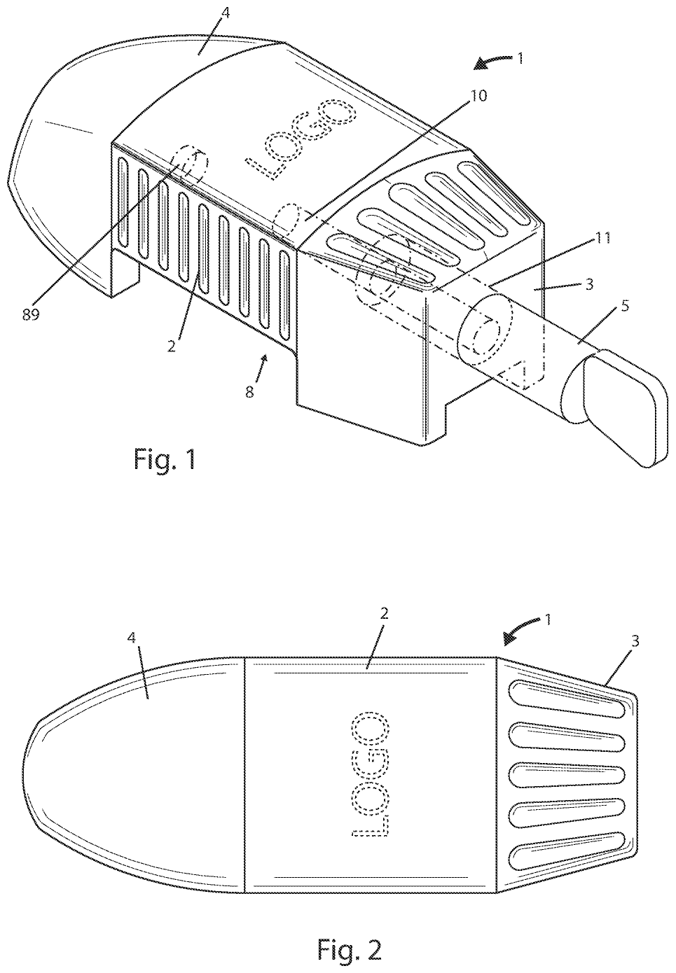

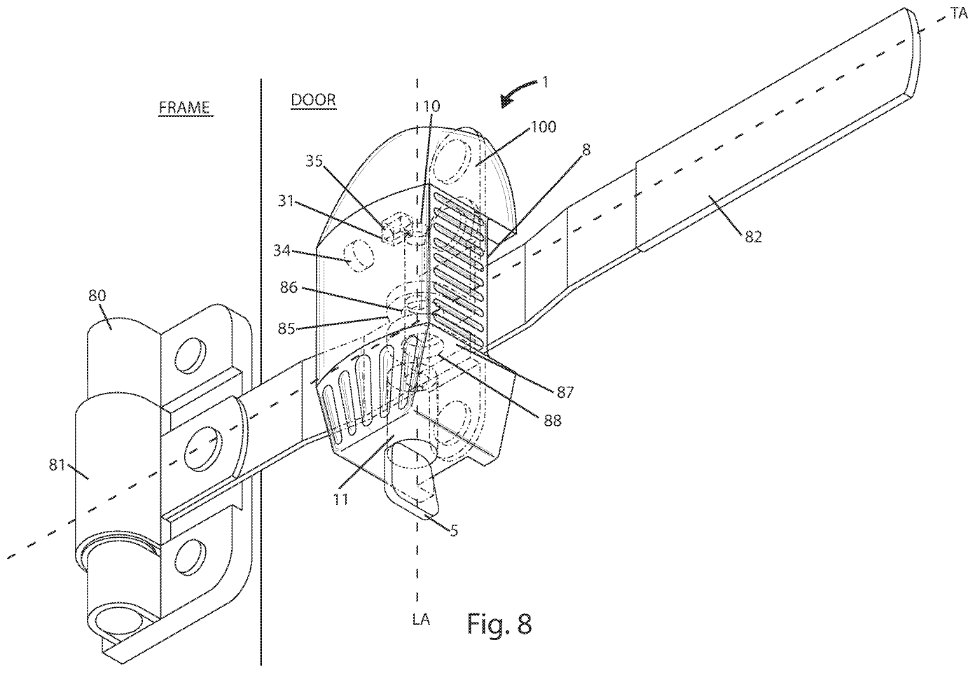

Referring first to FIGS. 1, 2 the hasp lock 1 is preferably made of a one piece aluminum casting. It has a key end 3, a central cavity 2 and a distal end 4. A key 5 rotates the tumbler 11 to allow the key 5 to push the locking pin 10 across the recess 8 and through the aligned upper and lower hasps (seen in FIG. 8) and then secured in hole 89 in distal end 4. To unlock and pull out the locking pin 10, the key 5 is reinserted, turned to grasp the tumbler 11, and pulled out to the position shown.

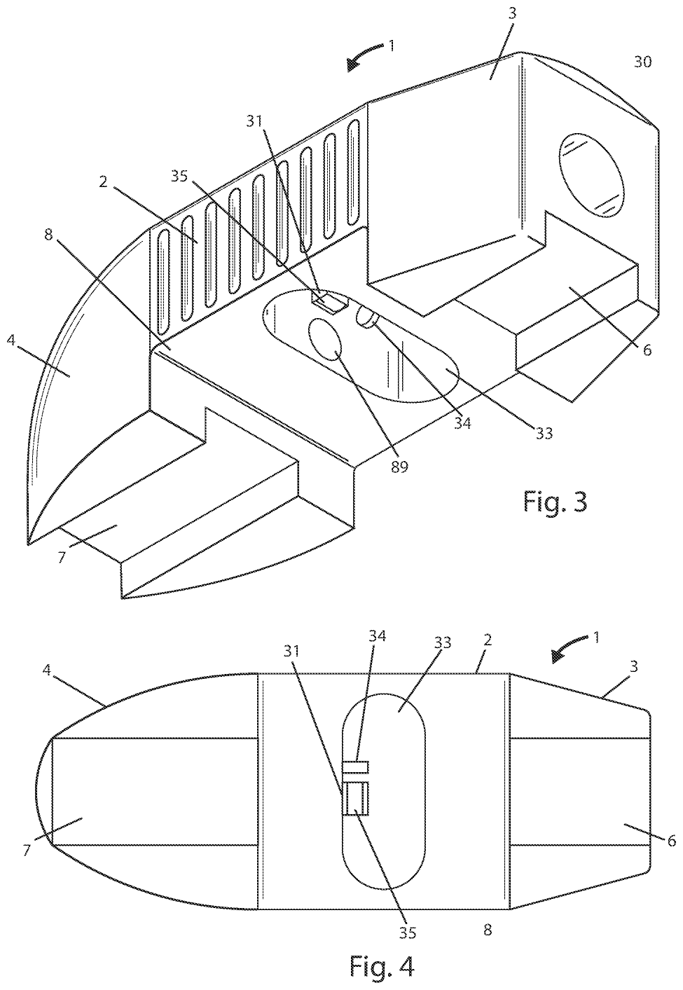

Referring next to FIGS. 3,4 the key hole 30 is seen. Lower slots 6,7 accommodate the door mounted hasp base 100 seen in FIG. 8. The recess 8 accommodates the lever arm 82 as seen in FIG. 8. An electronic (waterproof) housing 31 has a motion detector imbedded in it. A battery door 35 is shown, and a speaker 34 is shown. The housing 31 is preferably mounted above the hole 89 to allow the locking pin 10 to pass below the housing 31. Any design of the housing 31 to fit in the depression 33 of the central cavity 2 is equivalent so long as the locking pin 10 can pass through depression 33. Preferably a waterproof film (not shown) protects the speaker 34 yet allows a loud alarm sound to pass through. A low battery LED may be included in the housing 31. A cellular phone dial signal circuit and transmitter may be included in the housing 31.

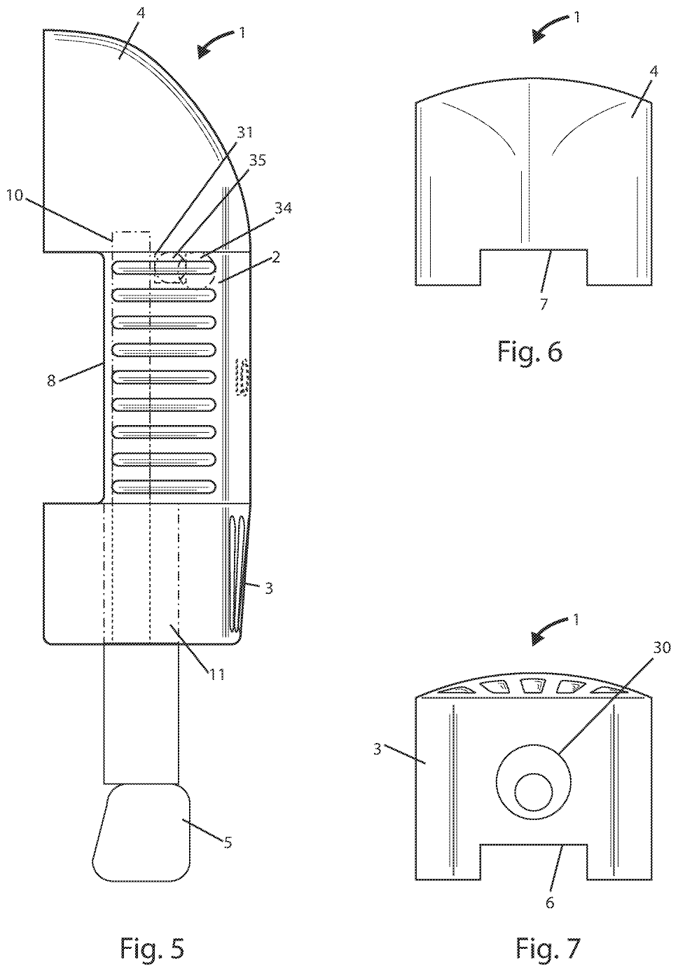

Referring next to FIGS. 5,6,7 optionally windows or slots 55 could extend through the central cavity 2 to enable the user to visually confirm the locking pin 10 is properly secured in hole 89.

Referring last to FIG. 8 the door frame FRAME has the locking bar 80 secured to it. A pivot mount 81 secures the lever arm 82 on the door DOOR. The locked position of the lever arm 82 is shown. The lower hasp 87 with hole 88 is rigidly mounted to DOOR. The upper hasp 85 with hole 86 is swivel mounted to DOOR in a known manner. Shown is the locked mode of the upper hasp 85, wherein the locking pin 10 extends through holes 86,88. A thief has no access to the electronic housing 31, and the speaker 34 cannot be covered up. Thus, any tampering with the hasp lock 1 will set off the motion detector and trigger the speaker 34. Equivalent embodiments use a vertical orientation of the lever arm 82.

The hasp lock 1 has a longitudinal axis LA and a transverse axis TA.

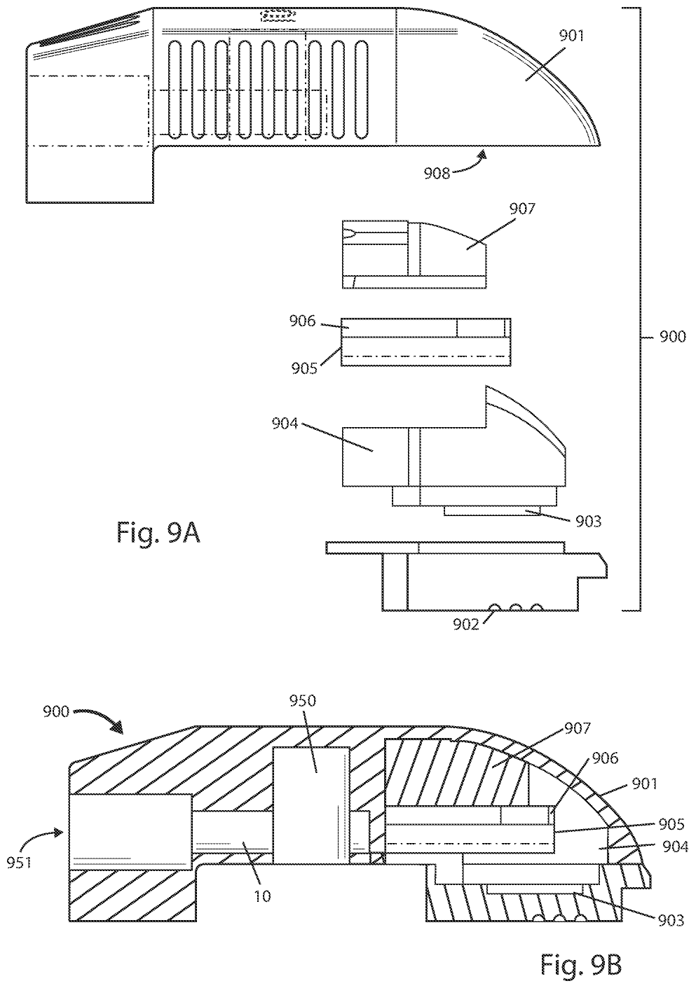

Referring next to FIGS. 9A,9B a lock 900 has a locking pin 10 that slides into anchor 950 in the locked mode. Distal end 901 from key end 951 has a cavity 908. A battery holder 905 retains batteries 906. A battery cover 907 slides over the battery holder 905. Then an electronic module 904 having a speaker 903 fits atop the battery holder 905. An outer shell 909 with speaker holes 902 connects to distal end 901 via screws (not shown).

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A door hasp lock comprising:
a body having a longitudinal axis and a transverse axis;
said body having a key hole in a key end along the transverse axis;
a slidable tumbler in the key end is attached to a locking pin that is slidable by a key in the key end to extend across a recess on a bottom of the body so as to lock into a hole in a distal end of the body relative to the key end; and
a pocket in the recess houses a motion detector having an alarm.
